(19) United States
(12) Patent Application Publication
(10) Pub. No.: US 2004/0135669 A1
(43) Pub. Date: Jul. 15, 2004

(54) Method and apparatus for controlling vehicle based communication devices

(76) Inventor: Stephen L. Muench-Casanova, Rochester, MI (US)

Correspondence Address: DAIMLERCHRYSLER INTELLECTUAL CAPITAL CORPORATION, CIMS 483-02-19, 800 CHRYSLER DR EAST, AUBURN HILLS, MI, 48326-2757, US

(21) Appl. No.: 10/342,943

(22) Filed: Jan. 15, 2003

(51) Int. Cl. H04Q 1/00; G05B 19/00

(52) U.S. Cl. 340/5.6; 340/5.72

(57) ABSTRACT

A system controls vehicle based communication devices that are connected to an electrical bus. A control module controls the communication devices based on the status of an access control device. The control module can use a privilege data store to determine the communication privileges a user is allowed for a particular status of the access control device. The control module can either completely or partially disable access to selected functions of communication devices based on the status of the access control device.

### FIELD OF THE INVENTION

The present invention generally relates to the control of communication devices and in particular relates to the control of vehicle based communication devices.

### BACKGROUND OF THE INVENTION

Telecommunications and transportation have become very basic human needs. Telecommunication devices are becoming an indispensable part of our present day human life for communicating with others. A large number of people around the world use automobiles for fulfilling their transportation needs. It was thus inevitable that the telecommunication and transportation needs intersect at some point. As a result of such an intersection, increasingly, telecommunication devices are becoming part and parcel of automobiles. Further, with the advent of internet enabled computing, telecommunication devices having computing power have emerged in the market. Typical examples of telecommunication and telematic devices that can be mounted on an automobile are radio based car-phones, cellular phones, satellite phones, wireless internet access terminals, computers, personal digital assistants, and electronic cameras. Presence of such telecommunication and telematic devices on a vehicle raises certain concerns as described next.

A typical automobile may be used by persons other than the owner of that automobile. Such other persons could be the owner's family members, employees, co-workers, valets, or friends. The risk of such other persons misusing the vehicle based telecommunication facilities is ever present.

Hence, there is a need to control access to the vehicle based telecommunication devices depending upon the type of the driver. There is a further need to provide facilities to allow the owner of the vehicle to customize the level and nature of access that other persons driving the vehicle should have. Implementation of a security system allowing specific level of access to the telecommunication systems of a vehicle should improve the safety, security, and privacy of the vehicle owner and other users. However, such implementation should generally be possible without requiring a large number of additional components.

### SUMMARY OF THE INVENTION

A system controls vehicle based communication devices that are connected to an electrical bus. An access control device is also connected to the bus. A control module controls the communication devices based on the status of the access control device. The control module can use a privilege data store to determine the communication privileges a user is allowed for a particular status of the access control device. The control module can either completely or partially disable access to the selected functions of communication devices based on the status of the access control device.

The system can provide restricted communication facilities to users such as valets when a valet key is inserted in an access control device like a car-lock. In such a situation a valet could make emergency calls, but not any personal calls.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a vehicle telecommunication control system mounted on an automobile;

FIG. 2 is a flowchart showing the operational steps involved in an embodiment of the present invention; and

FIG. 3 is a flowchart showing the operational steps in an embodiment that uses a smartcard.

### DETAILED DESCRIPTION OF THE PREFERRED EMBODIMENTS

The following description of the preferred embodiment(s) is merely exemplary in nature and is in no way intended to limit the invention, its application, or uses.

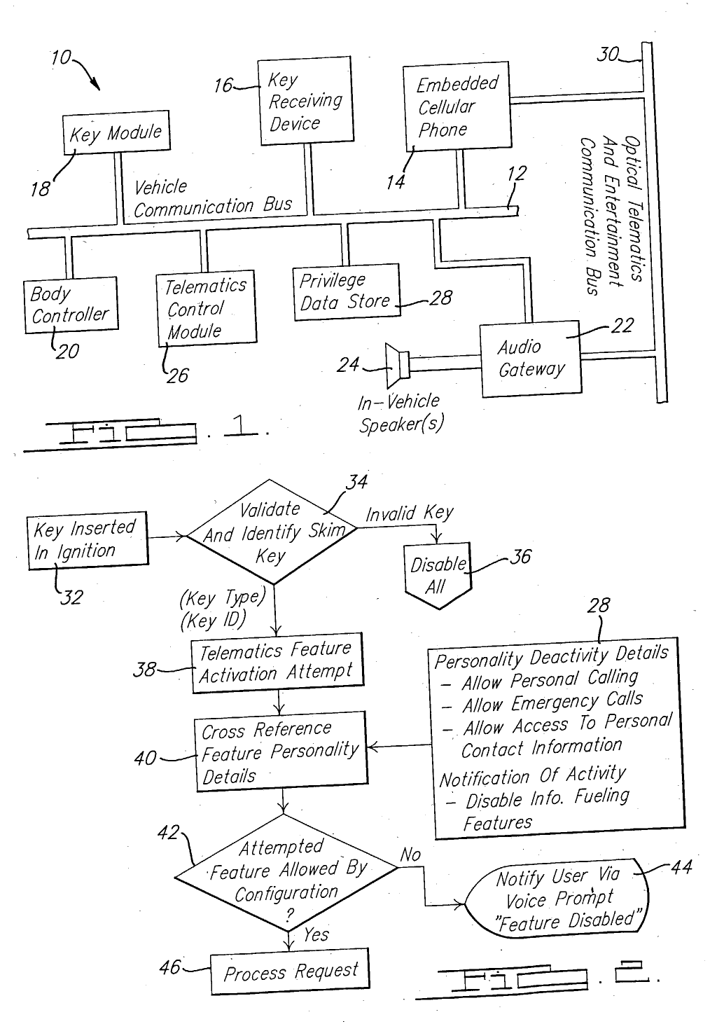

FIG. 1 shows a vehicle telecommunication control system 10 mounted on an automobile. A vehicle control bus 12 connects various electrical control systems and devices on the vehicle. A typical automobile may have several telecommunication and telematic devices installed on its structure. For sake of clarity, only a single exemplary embedded cellular phone 14 is considered here as a representative telecommunication or telematics device. Those skilled in the art will appreciate that the cellular phone is discussed here only for illustration purposes, and the same is a non-limiting example. Any number and type of telecommunication or telematic devices may be connected to the control bus 12 in a given automobile.

Keys and locks are common devices used to control access to automobiles. Several other devices and methods can be used to control access to the automobile. For example, smart cards, remote controls, key-pads, etc., can be used to control access to the vehicle. As an example, a lock and key mechanism is considered here as a non-limiting example, where the key includes a unique embedded electronic signature. Those skilled in the art would appreciate that any access control device or mechanism can be used in place of the exemplary lock-and-key discussed above.

A key receiving device 16 is connected to the control bus 12 and reads the electronic signature stored in the key when the user inserts the key into a vehicle lock. A key module 18 receives the electronic signature from the key receiving device 16. Key module 18 verifies the authenticity of the received electronic signature. The key module 18 generates a valid key signal if it is able to authenticate the key. A body controller 20 picks up the valid key signal sent by the key module 18 on the control bus 12 and initiates the ignition process by sending appropriate signals to the engine controls.

An audio gateway 22 is connected to the control bus 12. Speakers 24 are electrically connected to the audio gateway 22. In case the key module 18 could not authenticate or identify the inserted key's electronic signature, then an audible signal can be generated through the speakers 24 over the audio gateway.

A telematics control module 26 is used to control the operation of the exemplary device, the embedded cellular phone 14. The term “telematics” is used in a broad manner to cover the field of either telecommunication, computing or both. The telematics control module 26 is preferably implemented in the form of a hardware-software combination device. However, those skilled in the art will appreciate that the telematics control module 26 can be implemented as an exclusive hardware or software mechanism and that same does not limit the present invention in any manner.

The telematics control module 26 controls the user's access to the embedded cellular phone 14 depending upon the access privileges determined by the electronic signature embedded in the inserted key. The telematics control module uses a privilege data store 28, which stores the data related to privileges of specific type users. Further, an optical and telematic bus 30 can be provided to support a dedicated communication and control channel for the various telematic and optical devices mounted on the vehicle. After describing the structural arrangement of the present invention's one embodiment as above, the operational steps involved in the invention are described next.

The privilege data store 28 is a preferred way to store user multiple privileges. However, the control system 10 can also be constructed without using the privilege data store 28. In such a system, the telematic control module 26 can itself hold the privilege related information.

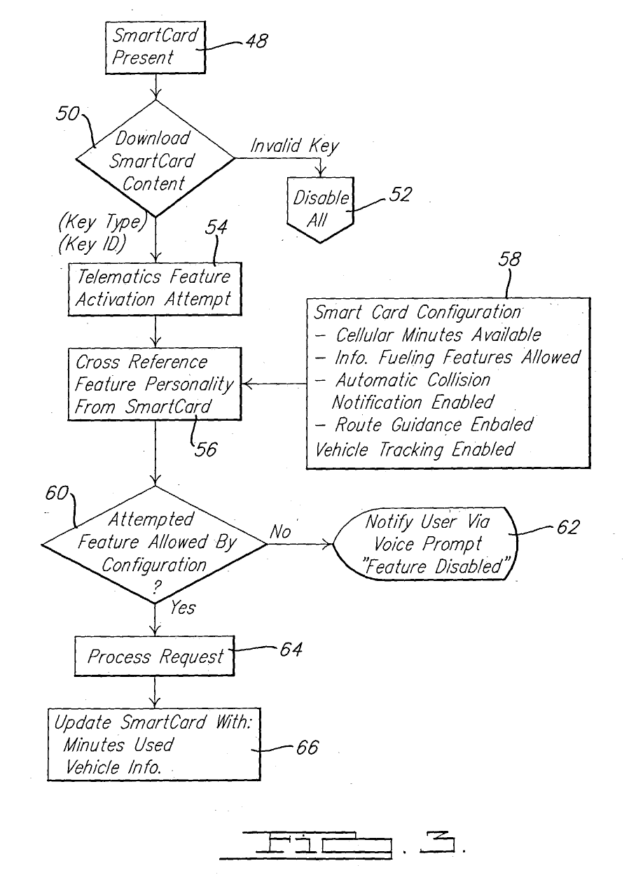

FIG. 2 is a flowchart showing the operational steps involved in an embodiment of the present invention. At Step 32, a key is inserted by the user in the ignition lock. The inserted key is validated and the embedded electronic signature is identified at step 34. In case the inserted key is invalid then the ignition system is disabled. Once the key is validated, the user can attempt to invoke any telecommunication device's function or feature, for example, dialing an embedded cell phone. In recognition of the user's attempt, telematic control module 26 (shown in FIG. 1) becomes active at step 38.

The telematic control module 26 (shown in FIG. 1), at step 40, cross references the telematic function or feature attempted to be invoked by the user with the privilege data store 28 (shown in FIG. 1). For example, if the key inserted by the user is a valet key that allows the user to call only emergency number(s) like ‘911’, then this privilege detail is stored in the privilege data store 28. The telematic control module 26 matches the number dialed, while the valet key is in an inserted status, against the privilege level of such valet key stored in the privilege data store 28.

A check is made at step 42, that if the user has called any number other than the emergency number(s) allowed by the privilege information stored in the privilege data store 28, then the dialing attempt is disallowed at step 44. The user may be appropriately warned by any method about the disallowed dialing attempt. For example, an audible prompt of “Feature Disabled” can be generated over the audio gateway 22 and through the speakers 24. Thus, a user of the vehicle will not be allowed to make any calls except the emergency numbers when the valet key is inserted. Hence, the system protects the telematics devices mounted on a vehicle from unauthorized use when the vehicle is being operated by valets or other users with restricted permissions, while at the same time, the system allows restricted access to emergency numbers that a valet may legitimately need to call in an emergency situation.

In case, the user who had inserted a valet key dials an emergency number, then the request is allowed to be processed at step 46. Thus, a vehicle based telematics or telecommunication device can be controlled by allowing access to its certain features or functions based on the access level specified by an access control device, for example, the above key with an electronic signature. Thus, the system allows disabling of certain selected features (like personal calling) while permitting emergency calling. The system provides for selective disabling of telematic features or functions depending upon the type of the user. The system eliminates the need for another human-to-machine interface (HMI), and hence achieves the functions described here without the user being required to remember additional codes. The system provides its security functionality without any need for additional components like a keypad, voice recognition system, passwords or code-reader, etc.

The range of options for controlling the communication devices will depend on the needs of a particular implementation. For example, a control scheme could allow access to emergency numbers for a valet key; access to numbers of friends, home phones and emergency numbers for a young driver in the owner's family; disable all access when an invalid key or card is inserted; or allow international calls only for the owner key, etc. Those skilled in the art will appreciate that a variety of control schemes can be adopted for type of access levels. Appropriate interface can be provided either within the car or by using an external module to allow configuration of a privilege data store 28 and the access control devices like the keys, cards, key-pads etc. Those skilled in the art will appreciate that the invention is not limited by any specific method used to configure the privilege data store 28 and the access control device.

FIG. 3 is a flowchart showing the operational steps in an embodiment that uses a smart-card. A smartcard typically is a portable card with embedded electronics to store required information. Any appropriate smartcard capable of storing data can be used in this embodiment. A smart card receiving device (not shown) detects if a smart card is inserted in the slot. At step 50, the smartcard content is downloaded. In case the inserted smartcard is invalid then at step 50, the system generates a signal to disable all systems.

The system waits for the user to activate any telematics feature as shown at step 54. At step 56, the system cross references the smartcard content downloaded at step 50 with the feature invocation attempted by the user. The smartcard data content can include a variety of items as shown at step 58. For example, the smartcard content can be the number of cellular minutes in form of a calling card, an indicator for allowing infofuelling features, an indicator for enabling automatic collision, an indicator for enabling route guidance, or an indicator for allowing vehicle tracking, etc.

Once the system is able to determine a match between the invoked feature and the smartcard content as shown at step 60, the request can be processed at step 64. After processing the request, the smart card content can be updated. For example, if the smartcard was used to store the minutes of phone call time allowed then the used-call time can be updated to reflect the duration of the last phone call. If the system fails to match the telematics feature invoked by the user with the smartcard data content then the user is preferably notified by a voice prompt at step 62. Thus, the present embodiment can be used in applications where access to the telematics features needs to be provided up to a limited level. For example, in a rental car situation where the customer can obtain a smartcard with prepaid or otherwise access to the telematics features on the car.

The control system allows selective and partial disabling of a communication device's functions. The control system performs such disabling of function based on the status of the access control device, for example, a valet key. A smartcard can be used to provide further functions as discussed above. A privilege data store can be used by the control system to store privileges of various types of users.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A vehicle based communication device control system, the system comprising:
an electrical bus mounted on the vehicle;
at least one communication device connected to said bus;
at least one access control device connected to said bus to control access to the vehicle; and
at least one control module connected to said bus, said control module controlling functioning of said communication device based upon a status of said access control device.

2. The system of claim 1 wherein said control module partially disables access to a set of functions of said communication device based upon a status of said access control device.

3. The system of claim 1, further comprising:
a privilege data store connected to said bus, said control module determining a match between contents of said privilege data store and said status of said access control device.

4. The system of claim 3 wherein said control module disables access to said telecommunication device when contents of said privilege data store fail to match said status of said access control device.

5. The system of claim 3 wherein said control module allows a user to access a permitted selection of functions of said telecommunication device, said permitted selection of function determined by the match between said privilege data store and said status of said access control device.

6. The system of claim 3 wherein said access control device comprises a key and said status being a valet status.

7. The system of claim 6 wherein said telecommunication device comprises a telephone mounted on the vehicle, said privilege data store defining said valet status as a permission to call a predetermined selection of numbers.

8. The system of claim 6 wherein said privilege data store defines said valet status as enabling a predetermined selection of emergency and safety functions related to the vehicle.

9. The system of claim 1 wherein said access control device comprises at least one of a lock and key, smart card, remote control, and keypad.

10. The system of claim 1 wherein said telecommunication device comprises at least one of a radio based car-phone, cellular phone, satellite phone, wireless internet access terminal, computer, personal digital assistant, and electronic camera.

11. The system of claim 1 wherein said control module blocks access to said communication device after a predetermined number of invalid attempts are made by a user to access the device.

12. The system of claim 1 wherein said communication device comprises a telematics device.

13. The system of claim 1 further comprising:
an interface module for setting said status of said access control device.

14. The system of claim 1 wherein said control module comprises at least one of a hardware device, a software mechanism, and a combined hardware-software mechanism.

15. A vehicle based communication device control system, the system comprising:
an electrical bus mounted on the vehicle;
at least one communication device connected to said bus;
an electronic memory holder;
at least one control module connected to said bus, said control module controlling functioning of said communication device based upon a status of said electronic memory holder.

16. The system of claim 15, wherein said electronic memory holder comprises:
a data set representing a user's rights to use said communication device.

17. The system of claim 15, wherein said electronic memory holder comprises an electronic smartcard having an electronic memory.

18. The system of claim 17 wherein said electronic memory of said smartcard stores usage permissions for the user having said smartcard to use said communication device.

19. The system of claim 17 wherein said control module updates information stored in said electronic memory when the user operates said communication device.

20. A method of controlling a communication device located on a vehicle, the method comprising:
providing an access control mechanism connected to an electrical bus mounted on the vehicle;
providing a control module connected to the bus; and
controlling operation of the communication device based on a status of said access control mechanism.

21. The method of claim 20 wherein said step of controlling allows partial operation of said communication device based on said status of said access control mechanism, said status being a restricted status.

22. The method of claim 21 wherein said step of controlling disables access to a set of predetermined functions of said communication device based on said restricted status.
